(19) United States
(12) Patent Application Publication
(10) Pub. No.: US 2007/0203764 A1
(43) Pub. Date: Aug. 30, 2007

(54) Method and apparatus for offering event tickets

(75) Inventor: Yoshiyuki Kokubo, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/584,358

(22) Filed: Oct. 20, 2006

(30) Foreign Application Priority Data
Feb. 24, 2006 (JP) 2006-048655

(51) Int. Cl. G06Q 10/00

(52) U.S. Cl. 705/5

(57) ABSTRACT

An apparatus for offering future event information to a present event ticket holder includes—a user database for storing predetermined information associated with present event tickets, a ticket database for storing event information associated with present and future events, and a unit for determining the status of the present event tickets. A follow-up program extracts a select present event ticket having a predetermined status from the user database, and event information of a select future event based on event information associated with the select present event ticket from the ticket database. The follow-up program then transmits the event information associated with the select future event to the holder of the select present event ticket.

### FIELD OF THE INVENTION

The present invention relates to an event ticket offering method and apparatus, and in particular, to a follow-up service for offering a ticket to an alternative event to the holder of an unused event ticket.

### BACKGROUND OF THE INVENTION

A technology is known for sending the URL (uniform resource locator) of a web page which provides information about an event before and after the opening date to the ticket holders of the event. However, no technology exists for performing a follow-up service for offering a ticket to the same or similar event as the original event to be held in the future to a ticket holder who could not attend the original event.

### SUMMARY OF THE INVENTION

The present invention is directed to an apparatus for offering future event information to a present event ticket holder, and includes a user database for storing predetermined information associated with present event tickets, a ticket database for storing event information associated with present and future events, and a unit for determining the status of the present event tickets. A follow-up program extracts a select present event ticket having a predetermined status from the user database, and event information of a select future event based on event information associated with the select present event ticket from the ticket database. The follow-up program then transmits the event information associated with the select future event to the holder of the select present event ticket.

### BRIEF DESCRIPTION OF THE DRAWINGS

FIG. 1 is a block diagram of an event ticket offering system in accordance with one embodiment of the present invention;

FIG. 2 is a flowchart describing the operation of an admission check unit shown in FIG. 1;

FIG. 3 is a flowchart describing the process for offering information regarding a future event to the holder of an unused ticket;

FIG. 4 is an example of a user database shown in FIG. 1;

FIG. 5 is an example of a ticket database shown in FIG. 1; and

FIG. 6 is an example of information regarding a future event transmitted to the holder of an unused ticket to a past event.

### DETAILED DESCRIPTION OF THE PREFERRED EMBODIMENTS

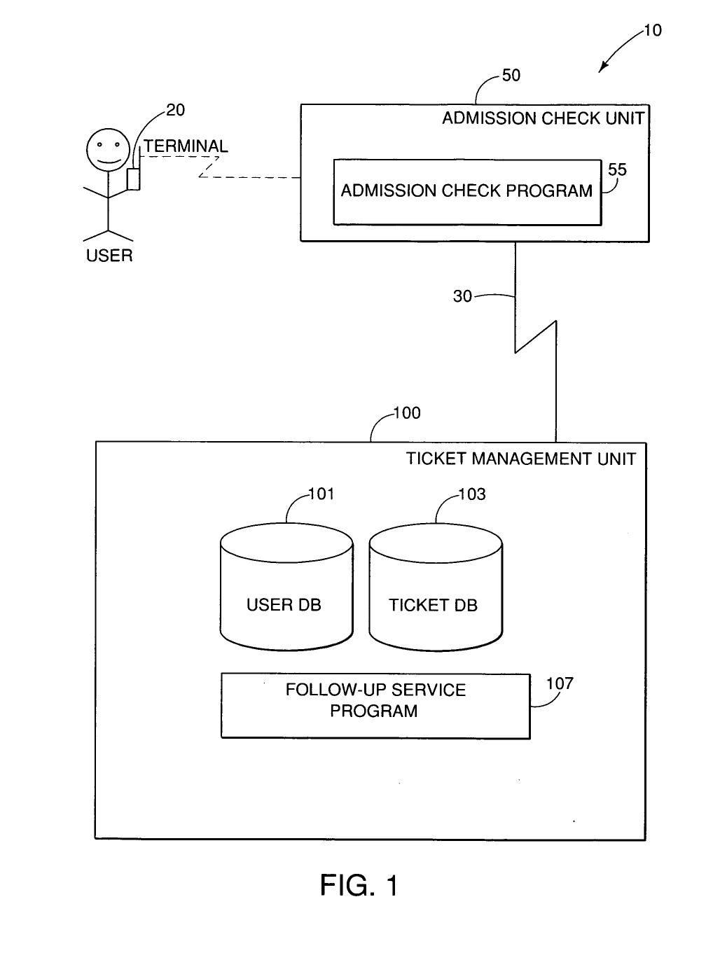

FIG. 1 is an event ticket offering system 10 in accordance with one embodiment of the present invention. The event ticket offering system 10 includes a terminal 20, an admission check unit 50 and a ticket management unit 100. The terminal 20 is a device for storing an electronic ticket. In one embodiment, the terminal 20 may be a mobile phone incorporating a non-contact IC card such as a Felica® IC card, which enables high speed transmission of data with high security. The electronic ticket would be stored in the IC card.

The admission check unit 50 includes an admission check program 55 for determining admission or non-admission of a ticket holder to an event. The admission check program 55 compares specific ticket information such as the ticket ID received from the terminal 20 of the ticket holder via wireless communication with a corresponding information stored in a ticket database (DB) 103 provided in the ticket management unit 100. The determination result is then transmitted by the admission check unit 50 to the ticket management unit 100.

In one embodiment, the admission check unit 50 may be a stand-alone electronic ticket reader such as Degi Gate® for reading non-contact IC cards. In another embodiment, ticket information may be provided on a paper ticket, and the admission check unit 50 would read the information directly from the paper ticket for determining admission. In this case, the paper ticket would be the terminal 20, and the admission check unit 50 a scanner for reading a barcode on the ticket, for example.

The ticket management unit 100 also includes a follow-up service program 107 for storing the determination results received from the admission check unit 50 via a predetermined communication network 30 to a user database (DB) 101 provided in the ticket management unit. The follow-up service program 107 further performs the function of extracting and transmitting to the holder of the unused ticket (i.e., when the admission check program 55 determines non-admission of a ticket holder) information regarding a future event which is the same or similar to the original event that was not attended by the ticket holder. The terminal 20, the admission check unit 50, and ticket management unit 100 may each be implemented in a computer having at least a processor and a memory.

The user DB 101 stores information relating to the ticket and the holder of the ticket such as a user ID, a ticket ID, and the use status of the ticket (admission or non-admission of the ticket holder). The ticket DB 103 stores information relating to scheduled events and event tickets such as ticket code, genre, artist name, opening date, place (event location), ticket ID, for example.

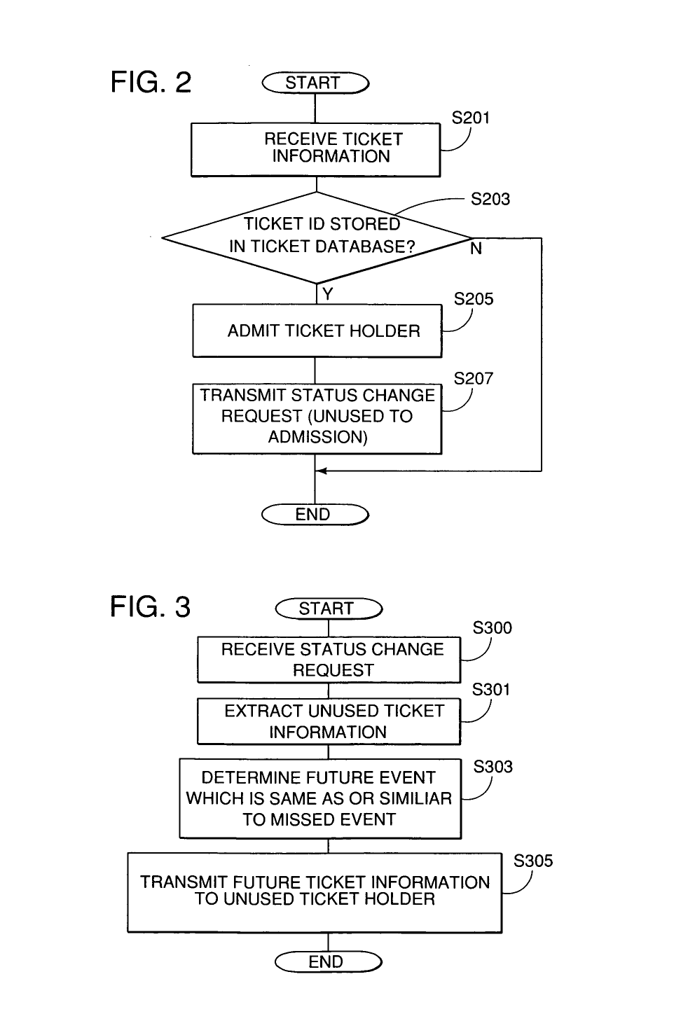

FIG. 2 is a flowchart for explaining the operation of the admission check program 55. When the ticket holder presents a ticket, whether paper or electronic, the admission check unit 50 retrieves the ticket information including the user ID and the ticket ID from the terminal 20 in step S201. In step S203, it is determined whether the same ticket ID exists in the ticket DB 103. If the same ticket ID exists in the ticket DB 103, the ticket holder is admitted to the event in step S205. In step S207, a status change request is transmitted to the ticket management unit 100 to change the status of the presented event ticket “admission” from to “unused” in the user DB 101.

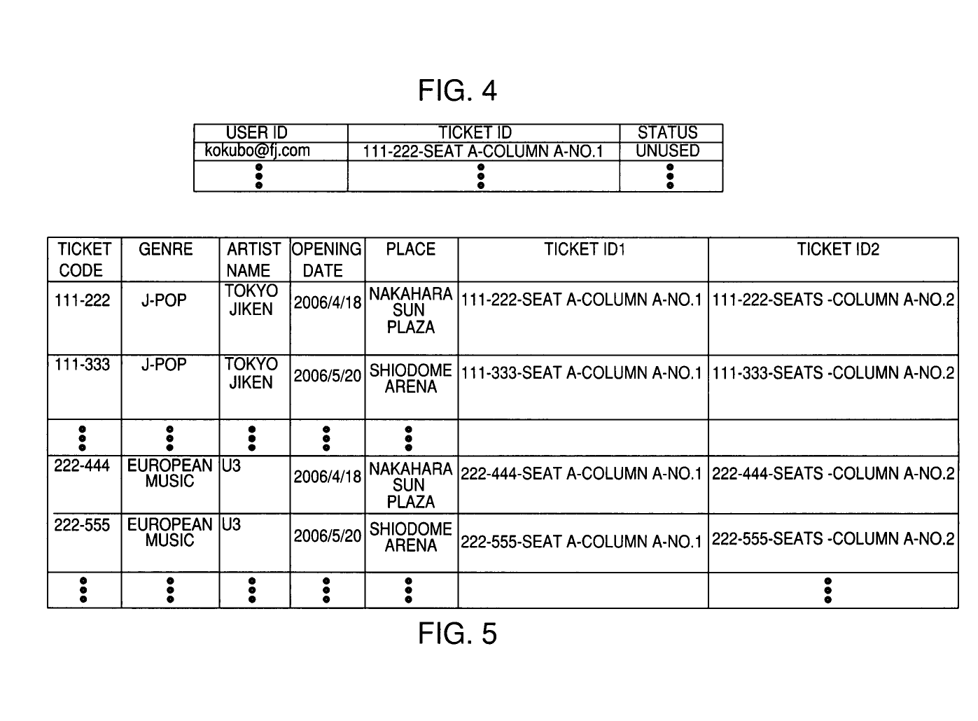

If the same ticket ID does not exist in the ticket DB 103 in step 203, the process is terminated, and the ticket holder is denied admission. FIG. 4 is an example of the user DB 101 storing the user ID: kokubo@fj.com; the ticket ID: 111-222-seat A-column A-No. 1; and the status: unused. While the user ID in FIG. 4 is in the form of an e-mail address, it can also be a telephone number or a street address.

Next, the operation of the follow-up service program 107 is described with reference to FIG. 3. In step S300, the ticket management unit 100 receives from the admission check unit 50, a status change request for changing the status of an event ticket in the user DB 101 corresponding to the ticket presented to the admission check unit 50. The status change request includes the user ID and the ticket ID of the ticket.

In step S301, the user ID of the tickets still having an “unused” status (i.e., unused tickets), along with the corresponding ticket ID are extracted from the user DB 101 at some predetermined time relative to the time of the corresponding events, e.g., one day after the event. In step 303, the ticket code of the ticket ID extracted in the step S301 is compared with other ticket information in the ticket DB 103 to determine whether there is a same or similar event. The ticket code includes information such as the artist name(s), genre, opening date, and location, for example.

FIG. 5 is an example of the ticket DB 103 storing the ticket codes, genre, artist names, opening dates, places, ticket ID1 and ticket ID2. In step S303, for example, the ticket information having the ticket code: 111-333, artist name: Tokyo Jiken, opening date: May 20, 2006, place: Shiodome Arena, might be determined to be the event of the same genre or the same artist to be held later, for the ticket (ticket code: 111-222-Seat A-Column A-No. 1) having an “unused” status.

In step S305, the ticket information extracted in step S303 is transmitted wirelessly (e.g., via text messaging on a mobile phone) or by a communication network (e.g., e-mail) to the holder of the unused ticket identified by the user ID extracted in the step S301.

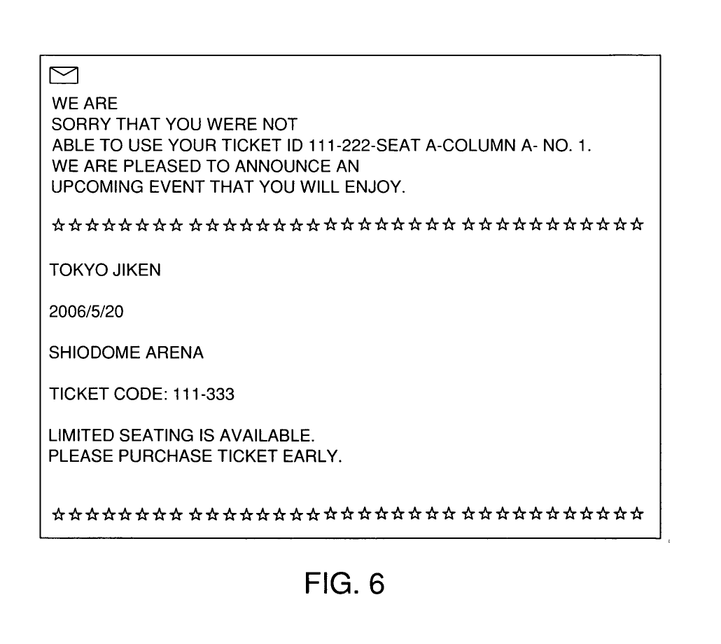

FIG. 6 is an example of the ticket information transmitted to the unused ticket holder. The ticket information shows the event to be held later that might be of interest to the unused ticket holder such as the artist name (“Tokyo Jiken”), the opening date (“May 20, 2006”), the place (“Shiodome Arena”), the ticket code (“111-333”) or the like. In this case, the artist name of the future event is the same as the event the unused ticket holder missed.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. Apparatus for offering future event information to a holder of a ticket to a present event, said apparatus comprising:
a user database for storing predetermined ticket information associated with a plurality of present event tickets;
a ticket database for storing predetermined event information associated with a plurality of present and future events;
means for determining a status of the present event tickets; and
follow-up means for extracting a select present event ticket having a predetermined status from the user database, and event information of a select future event based on ticket information associated with the select present event ticket from the ticket database;
wherein the follow-up means transmits the event information associated with the select future event to the holder of the select present event ticket.

2. The apparatus as defined in claim 1, wherein the follow-up means further performs a function of setting the status of the select present event ticket in the user database to the predetermined status when the status determining means determines that the select present event ticket has been received at the present event for admittance.

3. The apparatus as defined in claim 1, wherein the event information associated with the select future event is extracted from the ticket database at a predetermined time relative to the time of the select present event.

4. The apparatus as defined in claim 1, wherein the user database stores at least a user ID, a ticket ID and the status of each of the present event tickets.

5. The apparatus as defined in claim 4, wherein the ticket database stores at least a ticket code identifying the ticket ID of the present and future event tickets and event information associated with each of the present and future events.

6. The apparatus as defined in claim 5, wherein the ticket code for the select present event includes the predetermined event information including at least a name(s) of performer(s), genre and a location of the select present event; and
the user follow-up means extracts the ticket code of the future event having one or more of the same performer name(s), genre or the location as the select present event.

7. The apparatus as defined in claim 4, wherein the follow-up means transmits the event information associated with the select future event to the holder of the select present event ticket based on the user ID of the select present event ticket extracted from the user database.

8. The apparatus as defined in claim 7, wherein the follow-up means transmits the event information associated with the select future event to the holder of the select present event ticket via wireless and/or network communication.

9. The apparatus as defined in claim 8, wherein the follow-up means transmits the event information associated with the select future event to the holder of the select present event ticket via electronic mail or text messaging via a mobile phone.

10. The apparatus as defined in claim 1, wherein the status determining means determines the status of the present event tickets by reading and comparing the present event tickets presented to the status determining means with the present event tickets stored in the user database.

11. The apparatus as defined in claim 10, wherein the status determining means comprises an electronic ticket reader for reading the present event tickets.

12. A method for offering information regarding a future event to a holder of a ticket to the present event, said method comprising:
storing predetermined information associated with a plurality of present event tickets in a user database;
storing event information associated with a plurality of present and future events in a ticket database;
determining a status of the present event tickets;
extracting a select present event ticket having a predetermined status from the user database, and event information of a select future event based on event information associated with the select present event ticket from the ticket database; and
transmitting the event information associated with the select future event to the holder of the select present event ticket.

13. The method as defined in claim 12 further comprising setting the status of the select present event ticket to the predetermined status in the user database when the select present event ticket has been received at the present event.

14. The method as defined in claim 13, wherein the user database stores at least a user ID, a ticket ID and the status of each of the present event tickets.

15. The method as defined in claim 14, wherein the ticket database stores at least a ticket code identifying the ticket ID of the present and future event tickets associated event information of the present and future events.

16. The method as defined in claim 15, wherein the ticket code for the select future event to be transmitted to the holder of select present event ticket has at least one or more of the same performer name, genre or the location as the ticket code for the select present event.

17. The method as defined in claim 14, wherein the event information associated with the select future event is transmitted to the holder of the select present event ticket based on the user ID for the select present event ticket extracted from the user database.

18. The method as defined in claim 17, wherein the event information associated with the select future event is transmitted to the holder of the select present event ticket via wireless or network communication.

19. The method as defined in claim 13, wherein the status of the present event tickets is determined by comparing the present event tickets received at the event with the present event tickets stored in the user database.
